(19) United States
(12) Patent Application Publication
(10) Pub. No.: US 2006/0109877 A1
(43) Pub. Date: May 25, 2006

(54) External cavity laser with adaptive fiber bragg grating (FBG) for minimizing noise related to stimulated brillouin scattering (SBS) in dispersive fiber links

(76) Inventors: John W. Caton, Doylestown, PA (US); Dave Meloche, Upper Black Eddy, PA (US); Joseph Hober, Southampton, PA (US)

Correspondence Address: CHRISTIE, PARKER & HALE, LLP, PO BOX 7068, PASADENA, CA, 91109-7068, US

(21) Appl. No.: 11/159,570

(22) Filed: Jun. 21, 2005

Related U.S. Application Data
(60) Provisional application No. 60/581,433, filed on Jun. 21, 2004.

(51) Int. Cl. H01S 3/00

(52) U.S. Cl. 372/33; 372/38.08; 372/102

(57) ABSTRACT

An optical transmitter including an external cavity laser for generating an optical signal, and transmitting the optical signal over a dispersive fiber optic link. The optical transmitter includes an electronic circuit coupled to the external cavity laser to change spectral characteristics of the external cavity laser through changing physical properties of the external cavity laser by providing a periodic stress or an aperiodic stress to the external cavity laser, thereby reducing an effect of noise in a received signal arising from stimulated Brillouin scattering (SBS) generated in the dispersive fiber optic link.

### CROSS-REFERENCE TO RELATED APPLICATION

This application claims priority to and the benefit of U.S. provisional application no. 60/581,433 filed on Jun. 21, 2004, the entire content of which is incorporated by reference herein.

### BACKGROUND OF THE INVENTION

1. Field of the Invention

This invention relates to an optical transmission system for analog RF signals, and in particular to a directly modulated external cavity solid state laser in the optical transmission system. More particularly, the invention relates to the use of an electronic circuit coupled to the external cavity of the laser for affecting the physical properties of the laser cavity, and thereby providing a modified optical signal output from the laser which causes the received signal at the other end of the transmission system to reduce or minimize the effect of noise arising from stimulated Brillouin scattering (SBS) generated in the dispersive optical fiber link, which results in noise in the received signal and unacceptable quality in the demodulated RF signal.

2. Description of the Background Art

Directly modulating the analog intensity of a light-emitting diode (LED) or semiconductor laser with an electrical signal is considered among the simplest methods known in the art for transmitting analog signals, such as sound and video signals, on optical fibers. Although such analog techniques have the advantage of significantly smaller bandwidth requirements than digital pulse code modulation, or analog or pulse frequency modulation, amplitude modulation may suffer from noise and nonlinearity of the optical source.

For that reason, direct modulation techniques have been used in connection with 1310 nm lasers where the application is to short transmission links that employ fiber optic links with zero dispersion. For applications in metro and long haul fiber transmission links, the low loss of the link requires that externally modulated 1550 nm lasers be used, but such external modulation techniques are complex and expensive. The present invention is therefore addressed to the problem of providing a simple and low cost system for direct modulation of a laser at 1550 nm so that the analog optical output can be used in single mode fiber used in metro and long haul optical networks, with potential customer savings of thousands of dollars in the cost compared to externally modulated systems.

Direct modulation of lasers at 1550 nm is known for use in digital optical transmission systems such as dense wavelength division multiplexing (DWDM) systems. However, directly modulated fiber optic 1550 nm transmitters for use in cable television (CATV) hybrid fiber co-axial (HFC) systems have generally been limited to low channel load quadrature amplitude modulation (QAM) applications and/or short optical fiber spans.

Suitable low chirp lasers for use in an analog optical transmission system at 1550 nm are not known in the prior art. One type of low chirp laser is the external cavity laser, which is used in digital optical transmission systems that is a commercially available product.

In addition to the low chirp characteristics required for an analog optical transmission system at 1550 nm, the system must be highly linear. Distortion inherent in certain analog transmitters prevents a linear electrical modulation signal from being converted linearly to an optical signal, and instead causes the signal to become distorted. These effects are particularly detrimental to multi-channel video transmission which requires excellent linearity to prevent channels from interfering with each other. A highly linearized analog optical system has wide application in commercial TV transmission, CATV, interactive TV, and video telephone transmission.

Although external cavity lasers have been proposed by manufacturers such as K2 Optical, the performance of such lasers generally suffer from practical disadvantages. Most practical commercial applications in CATV systems require optical power on the order of 20 dBm to be launched into the fiber, yet the power output of the prior art external cavity lasers is limited to about 13 dBm into a 25 km fiber.

Distributed feedback (DFB) lasers having relatively high optical line-width, coupled with poor dispersive characteristics of SMF-28 fiber, cause group velocity dispersion (GVD) generated composite second order (CSO) distortions that hinder the long distance transmission of standard AM modulated broadcast CATV channel plans (e.g., 40 to 128 analog channels). Further, stimulated Brillouin scattering (SBS) effects that depend on the optical launch power and the total fiber length may also be caused. The SBS can degrade DWDM system performance.

The SBS is an opto-acoustic nonlinear process that can occur in single mode optical fibers. This optically induced acoustic resonance forms a refractive-index grating within the fiber which effectively limits the amount of optical power that can be successfully transmitted through the single mode optical fiber.

The SBS can perhaps be best explained in terms of three waves in an optical fiber. When an incident wave (also known as “pump wave”) propagating along the optical fiber reaches a threshold power (which may vary), it excites an acoustic wave in the optical fiber. The optical properties of the optical fiber such as the refractive index are altered by the acoustic wave, and the fluctuation in the refractive index scatters the incident wave, thereby generating a reflected wave (also known as “Stokes wave”) that propagates in the opposite direction. The SBS refers to this scattering.

Because of the scattering, power is transferred from the incident wave to the reflected wave, and molecular vibrations in the optical fiber absorb the lost energy, because of which, the reflected wave has a lower frequency than the incident wave. Hence, the scattering effect can result in attenuation, power saturation and/or backward-propagation, each of which deteriorates the DWDM system performance. Hence, the attenuation is caused by the transfer of power from the incident wave to the acoustic and reflected waves. Due to power saturation, there is a limit to the maximum amount of power that can be transmitted over the optical fiber. Also, the backward propagation wave can create noise in transmitters and saturate amplifiers.

The SBS threshold of SMF-28 optical fiber is dependent on the fiber length, optical input power and the line width of the optical source, and is generally defined at approximately 6 dBm for narrow line width lasers. Limiting the optical power to less than 6 dBm would severely limit the overall end of line, carrier to noise ratio (CNR) due to low optical receiver input powers, or require system designers to limit overall fiber lengths.

Recent advancements in external cavity diode laser (ECDL) have further highlighted the need for a suitable solution to the SBS problem. Current ECDL devices exhibit un-modulated optical line widths orders of magnitude narrower than commercially available DFB lasers (i.e., 10 kHz). As anticipated, this narrow line width has been shown to provide superior CSO performance in fiber lengths up to 80 km. Unfortunately, this performance advantage is currently obscured by the very low chirp characteristics of the ECDL structure.

As shown in FIGS. 1A and 1B, the mechanical structure of the ECDL device of FIG. 1B is different from the standard DFB laser configuration shown in FIG. 1A.

In an optical transmitter 10 having a standard distributed feedback (DFB) laser topology of FIG. 1A, a DFB laser 12 (which may be a narrow band optical source) incorporates a wavelength specific optical filter directly into an active layer of the optical source, thereby realizing a relatively narrow line width optical source. The DFB laser 12 is coupled via a lens 14 to a single mode fiber (“SMF”) 16 having a core 18. Linearization of optical and other nonlinear transmitters has been studied for some time, but current commercial devices based on DFB lasers are relatively expensive.

In an optical transmitter 20 having a standard external cavity diode laser (ECDL) topology of FIG. 1B, a broadband optical source 22 incorporates a wide band optical source (which may be a semiconductor laser) with a passive optical wavelength filter to yield an extremely narrow line width optical source. A fiber Bragg grating (FBG) 27 formed in a core 28 of an optical fiber 26 forms one of the reflectors of the laser cavity in the ECDL. A lens 24 is disposed between the broadband optical source 22 and the optical fiber 26.

An FBG forms one of the reflectors of the laser cavity in an ECDL. Since the wavelength determining cavity is removed from the active device, RF chirp characteristics generally depend on the design and manufacture of the optical filter. Hence, in this design, chirp characteristics may be significantly reduced but not entirely removed.

Traditional methods of SBS suppression by directly modulating the wideband optical source with either the desired AM modulation signals or a dedicated pilot tone may be ineffective. Standard approaches to solve this problem have been limited to modification in the manufacture of the FBG to increase its inherent frequency chirp characteristics. This approach suffers from both manufacturing difficulties as well as laser to laser repeatability issues as the ECDL's modulation linearity is also dependent on the FBG. Very small improvements in Chirp have been demonstrated using this technique to date.

In order to effectively utilize this new family of narrow line width source lasers, in directly modulated CATV fiber optic transmitters used in systems that incorporate optical launch powers in excess of the natural SBS limit, a new technique for SBS suppression and linearity control is desirable.

Therefore, it is desirable to provide an improved method and apparatus for SBS suppression in a DWDM system.

### SUMMARY OF THE INVENTION

It is an aspect of the present to provide an improved optical transmission system using a directly modulated laser.

It is another aspect of the present invention to provide a low chirp external cavity laser for use in a 1550 nm analog optical transmission system.

It is also another aspect of the present invention to provide a control circuit to provide thermal/mechanical stress to the fiber Bragg grating of an external cavity laser used in a 1550 nm analog optical transmission system.

It is still another aspect of the present invention to provide a low chirp analog optical transmission system with SBS suppression suitable for long haul dispersive optical fiber media.

It is still another aspect of the present invention to provide a periodic or aperiodic pulse signal to vary the ambient temperature and thereby modify or control the optical characteristics of a low chirp laser used in an analog optical transmission system suitable for long haul dispersive optical fiber media.

It is also an aspect of the present invention to provide a direct modulation and SBS related noise suppression in a broadband analog optical transmission system.

It is another aspect of the present invention to provide a dither signal that may be periodic or non-periodic that will change the response of an FBG.

In accordance with an aspect of the present invention, an application of external stress to a Bragg grating so as to dither the response of the grating, lessens unwanted SBS in optical transmission systems. The frequency of dithering should be sufficient to exceed the Brillouin bandwidth.

In accordance with an aspect of the present invention, an application of external stress to an FGB in a periodic or non-periodic manner so as to dither the response of the grating lessens unwanted SBS in optical transmission systems. Preferably, periodic stress should be applied.

In an exemplary embodiment according to the present invention, an optical transmitter includes an external cavity laser for generating an optical signal, and transmitting the optical signal over a dispersive fiber optic link, and an electronic circuit coupled to the external cavity laser to change spectral characteristics of the external cavity laser through changing physical properties of the external cavity laser by providing a periodic stress or an aperiodic stress to the external cavity laser, thereby reducing an effect of noise in a received signal arising from stimulated Brillouin scattering (SBS) generated in the dispersive fiber optic link.

In another exemplary embodiment according to the present invention, in an optical system having an optical transmission source in a form of a light source optically coupled with an in-line grating to form a laser, a method of lessening effects of noise in a received signal arising from stimulated Brillouin scattering (SBS) generated in a dispersive fiber optic link optically coupled with the laser, is disclosed. A time varying stress is applied to the in-line grating so as to change spectral characteristics of the in-line grating.

In yet another exemplary embodiment according to the present invention, a system includes a dispersive fiber optic link, a laser optically coupled with the dispersive fiber optic link, wherein the laser includes a narrow band optical source and an FBG forming an output facet of the laser, and means for dithering the spectral response of the FBG to reduce noise in a received signal arising from SBS generated in the dispersive optical fiber link.

In yet another exemplary embodiment according to the present invention, a system for lessening effects of noise in a received signal arising from SBS generated in a dispersive optical fiber link, is provided. The system includes a narrow band laser including an FBG for transmitting an optical signal, and means for applying a time varying stress to the FBG so as to change its operating characteristics, the time varying stress being dithered with a frequency of 50 to 500 Hertz.

In yet another exemplary embodiment according to the present invention, an external cavity laser is provided. The external cavity laser includes a butterfly package having peripheral walls that define a cavity and a plurality of pins extending from at least one of the peripheral walls. The external cavity laser also includes a laser for generating an optical signal, an FBG and a heating element disposed adjacent to the FBG. The dispersive fiber optic link receives the optical signal and carries the optical signal from the laser to a remote receiver. The FBG is disposed between the laser and the output. A signal is applied through one of the pins to the heating element, thereby alternately heating and cooling the heating element.

### BRIEF DESCRIPTION OF THE DRAWINGS

FIG. 1A is a schematic diagram showing an optical transmitter having a conventional distributed feedback (DFB) laser topology.

FIG. 1B is a schematic diagram showing an optical transmitter having a standard external cavity laser (ECL) topology, wherein a fiber Bragg grating (FBG) forms one of the laser facets at an output side of the laser.

FIG. 2 is a schematic diagram of an optical transmitter having an ECL topology in an exemplary embodiment according to the present invention, wherein a spectral response of the FBG is dithered.

FIG. 3 is a schematic perspective diagram of an ECL package in an exemplary embodiment of the present invention.

FIG. 4A is a plot showing a spectrum of optical or RF power of a prior art ECL, measured over a frequency range, in dB.

FIG. 4B is a plot showing a spectrum of optical or RF power of an ECL of an exemplary embodiment according to the present invention, measured over a frequency range, in dB.

### DETAILED DESCRIPTION

Briefly, and in general terms, the present invention provides an electronic circuit coupled to the external cavity of a semiconductor laser for affecting the physical properties of the laser cavity, and thereby providing a modified optical signal output from the laser which causes the received signal at the other end of the transmission system to minimize the effect of stimulated Brillouin scattering (SBS) generated in the dispersive optical fiber link. More particularly, the present invention provides a recurrent thermal variation of the order of a few degrees Fahrenheit or Celsius with a cycle time of 50 to 500 Hertz to the external cavity, and preferably 180 to 220 Hertz.

By applying a periodic or aperiodic current signal to a substrate located adjacent the fiber Bragg grating, a thermal variation and physical stress is applied to the cavity. The applied signal results in recurrent heating and cooling of the cavity, which affects its optical properties. The temperature range, cycle time, and periodicity (or aperiodicity) is chosen such that the SBS resulting noise of the received signal transmitted over the dispersive fiber link is reduced or minimized, enabling transmission of high bandwidth analog RF signals over long lengths of dispersive single mode fiber optic media at an optical wavelength of 1550 nm. Preferably, a periodic current signal is provided.

Hence, exemplary embodiments of the present invention provide a solution which substantially lessens unwanted SBS and in some instances essentially suppresses it.

The resonance of a fiber Bragg grating (FBG) depends on the index of refraction of the core as well as the periodicity of the grating. Both of these parameters are affected by changes in mechanical stress and temperature. This characteristic of FBG generally has been seen as an obstacle to overcome, however, in exemplary embodiments of the present invention, this sensitivity is used to solve the technical problems of SBS suppression and overall device linearity in optical systems.

The SBS suppression, in a single mode optical fiber, can be achieved by either broadening the optical carrier or by FM/PM modulating a narrow line width source at a rate greater than the Brillouin bandwidth. Traditionally this frequency deviation is derived from the inherent chirp of the modulated optical source or by directly modulating an external LiNbO3 phase modulator with an appropriate pilot signal. Exemplary embodiments of the present invention described herein below, define a new and novel approach to this limiting problem.

By applying an external stress upon the FBG, used within or outside of an optical laser source, the optical characteristics of the grating can effectively be modified in a way which enhances the SBS suppression of said device in an optical system. A constant stress placed evenly across the FBG can be used as a useful method for modifying the operating wavelength of the source laser. While this phenomenon is interesting, a more intriguing application of constant stress can be observed when the stress is applied upon a localized area within the active region of the FBG. This stress differential in the FBG can be used to create an effective chirped grating topology from an otherwise standard FBG. Further, the characteristics of this stress induced chirped grating can be actively modified to compensate for a number of laser shortcomings.

The FBG with stress-induced chirp will modify the laser's inherent chirp characteristics, thereby improving SBS suppression in the fielded system. The amount of chirp induced can be modified by varying the amount of stress applied to the FBG and the slope of this chirp can be manipulated by changing the location of the applied stress. This feature allows the user to change both the SBS suppression capability as well as providing dispersion compensation for various lengths of optical fiber.

Alternatively, the stress-induced chirp can be made to compensate for the source laser's inherent second order modulation non-linearities reducing or eliminating the need for electronic pre-distortion. In addition, when multiple sources of stress are applied to the FBG, multiple chirped gratings may be formed within the original uniform grating, yielding additional desirable effects.

In exemplary embodiments according to the present invention, stress is dynamically applied on the FBG. If the stress is applied in a time varying fashion, and preferably in a periodic fashion, it can be observed that the optical wavelength varies in accordance with the applied stress. If the frequency and the amount of stress is sufficient to significantly change the operating wavelength, improvements in SBS suppression can be achieved. Experiments involving systems with 60 km of SMF-28 single mode fiber have shown that optical launch powers in excess of +20 dBm can be achieved. This should not be construed as a design limit and much higher SBS thresholds may be possible.

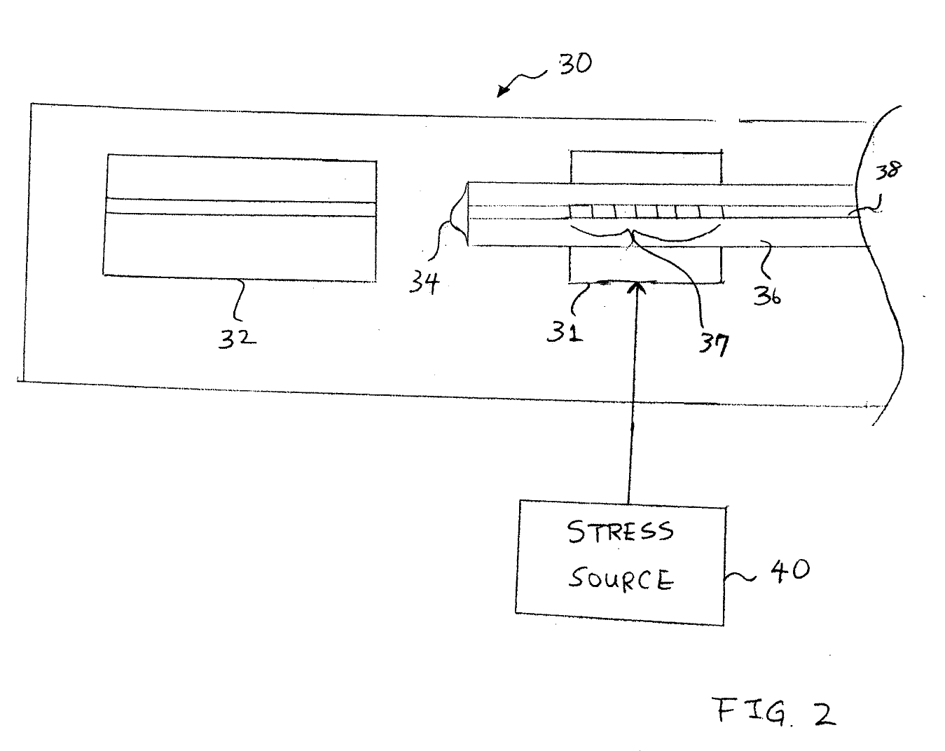

As can be seen in FIG. 2, an optical transmitter 30 having an ECL topology in an exemplary embodiment of the present invention includes an optical source 32, which may be a semiconductor laser, coupled through a microlens 34 to an optical fiber 36. The microlens 34 can be replaced by any other suitable lens for coupling the divergent captured light into a single mode optical fiber 36. The optical fiber 36 has an FBG 37 formed in its core 38. The optical source 32 preferably is a broadband optical source, but it may also be a narrow band optical source.

The ECL of FIG. 2 may be a narrow band laser, and a frequency of the ECL is varied by stressing the FBG, wherein the frequency of the ECL is dithered by varying the stress upon the FBG. The time varying stress applied to the FBG should be at a rate that is sufficient to substantially lessen the SBS effects.

The FBG 37 is disposed on a substrate 31. The optical transmitter 30 also includes a stress source 40, which applies a periodic or aperiodic stress to a portion of the substrate proximate to the FBG 37. The stress source 40 may be a controllable thermal heat source including a heating element for varying the spectral characteristics of FBG by applying a time varying stress. The stress source 40 may also include a thermal mechanical transducer for applying a time varying stress to the substrate 31, thereby modifying a period of the FBG using thermally induced time varying refractive index changes.

The spectral characteristics may include an optical period of the FBG and/or an amount of chirp on the FBG. The change in the optical period may be a combination of a change in a physical period and a change in a refractive index of the FBG. The application of the time varying stress to the FGB changes a period of the FBG and/or a refractive index of the FBG in a time varying manner. The FGB may also be referred to as an in-line grating.

In an exemplary embodiment, the stress source 40 includes a current source, which provides a current to the substrate 31 on which the FBG 37 is mounted. Heat is generated by the applied current, which heat provides a thermal stress to the portion of the substrate proximate to the FBG 37. The thermal stress changes optical characteristics, thereby suppressing SBS.

In the preferred embodiment, the current is applied periodically. By way of example, a temperature is cycled by a few degrees Fahrenheit (° F.) or Celsius (° C.) at a relatively large number of times (e.g., 200) a second. By way of example, the frequency of temperature cycle may be in the order of 50 Hz to 500 Hz. In an exemplary embodiment, the frequency of temperature cycle may be 180 Hz to 220 Hz. Because of the relative rapid current pulse, the FBG is rapidly heated and cooled. In an alternate embodiment, the current is applied aperiodically, randomly and/or pseudo-randomly by the stress source 40. In other embodiments, the stress source 40 may provide the stress mechanically or in any other suitable manner to the substrate 31. By way of example, the mechanical apparatus such as a piezoelectric transducer can be used in the place of the heat source to dither the spectral characteristics of the grating, thereby varying laser cavity's output response. Although not shown in FIG. 2, a great span of transmission line is coupled to the other end of the optical fiber 36 for receiving and transmitting light from the optical transmitter 30.

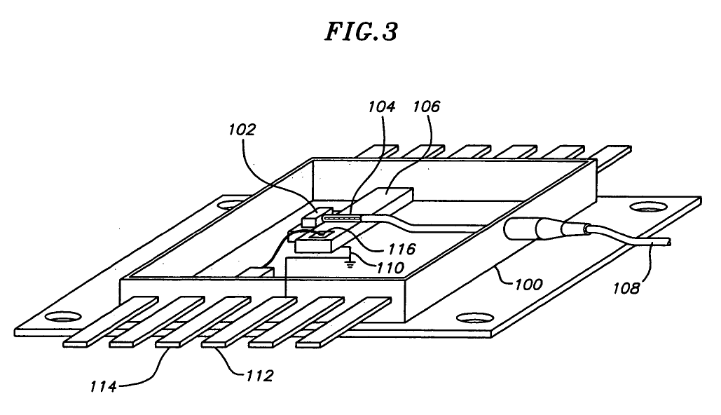

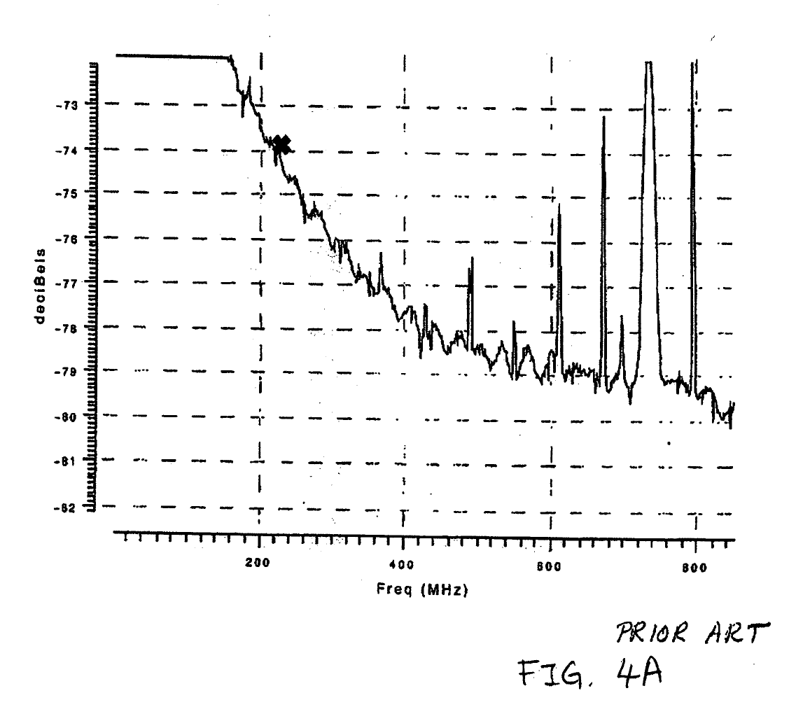

As can be seen in FIG. 3, an optical transmitter according to an exemplary embodiment can be packaged in a butterfly package 100. The optical transmitter includes a laser 102 (e.g., a semiconductor laser) coupled to an FBG 104, which is in-line with the laser 102. The FBG 104 is mounted on a mount 106 (or mounting lock), which is a heat conductive block. The mount 106, for example, can be made of any suitable heat conducting material such as metal, semiconductor or the like. An output of the optical transmitter from the FBG 104 is transmitted through an optical fiber 108, which may be an SMF-28 optical fiber, for example. The optical fiber 108 may also be referred to as a dispersive optical fiber link.

A ground 110 is provided to the mount 106 via a ground pin 112 of the butterfly package 100. Further, in the case of the preferred embodiment, a periodic signal is provided to the mount 106 at a contact 116 through one of the pins of the butterfly package 100. The periodic signal, by way of example, can be a current for periodically (e.g., at 200 cycles per second) heating and cooling the mount 106 such that a thermal stress is provided to the FBG 104. In alternate embodiments, the signal provided to the mount 106 may be aperiodic, random and/or pseudo-random.

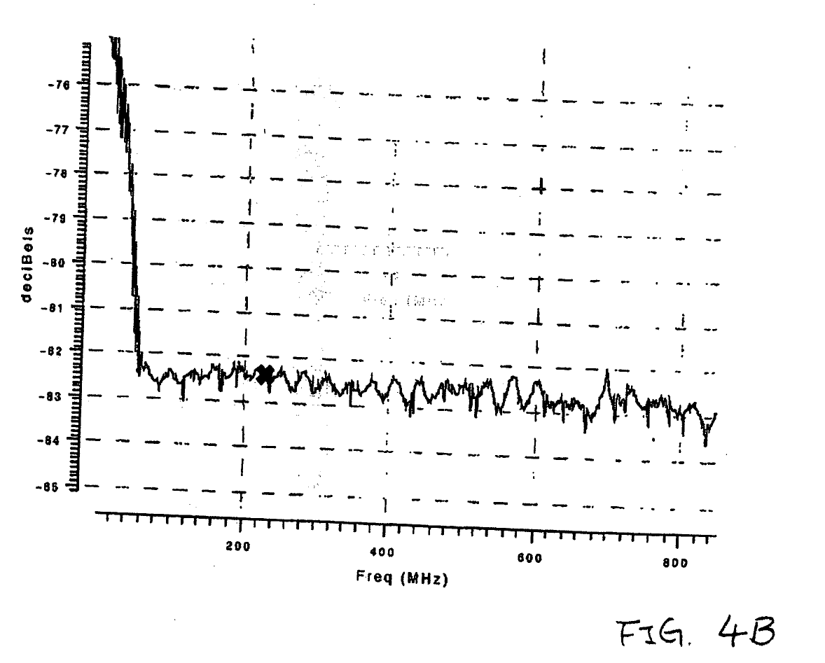

FIG. 4A and 4B, respectively, are a spectrum without suppression for a 25 km fiber, 22 dBm erbium-doped fiber amplifier (EDFA) launch, and a spectrum with suppression for a 25 km fiber, 22 dBm EDFA launch.

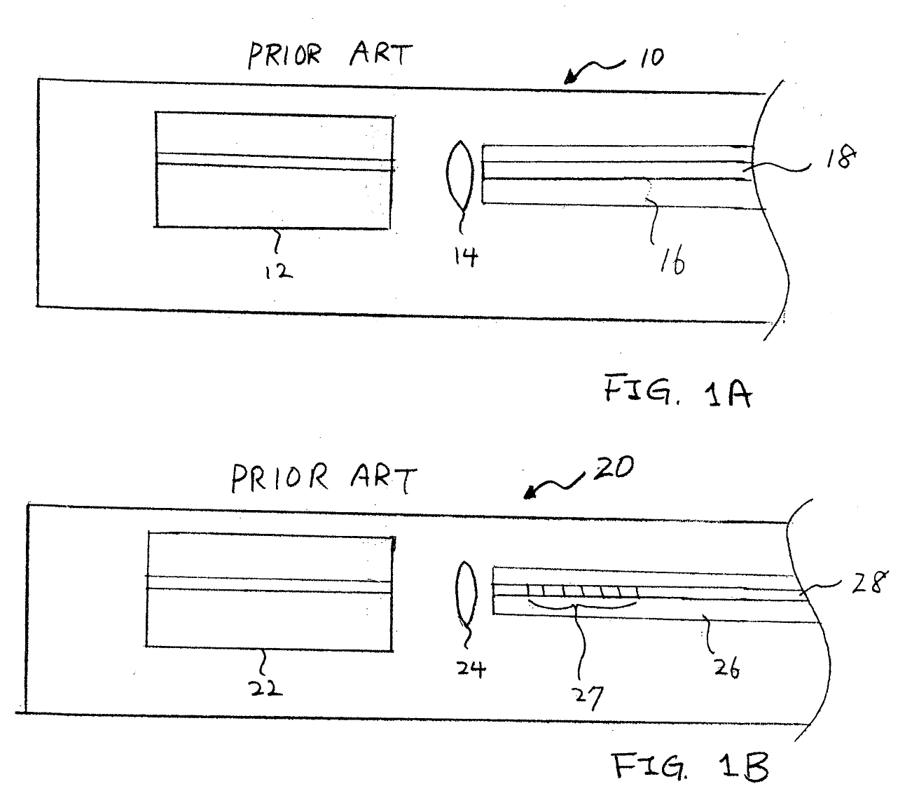

It can be seen in FIG. 4A, that a plot of a spectrum of optical or RF power measured over a frequency range in dB includes a lot of noise, especially in the low frequency portion of the band, for a prior art ECL, which is shown in FIG. 1B, for example. This is in contrast to a plot of a spectrum of optical or RF power measured over a frequency range in dB, which is shown in FIG. 4B.

The difference between the noises can perhaps be better shown by comparing the noise near 240 MHz for the plots of FIGS. 4A and 4B. As ‘X’ marks in these plots indicate, the noise level at about 240 MHz is about −74 dB in the prior art ECL as illustrated in FIG. 4A, but the noise level at about 240 MHz is less than −82 dB in the plot of FIG. 4B.

A combinations of static and dynamic applications of stress may yield mutual benefits and both applications of stress may be applied concurrently to provide a suitable or an optimum amount of SBS suppression, dispersion compensation and/or modulation linearity.

A stress can be applied to the FBG efficiently using a number of techniques. For example, point sources of heat may be applied to the FBG itself to induce a thermal gradient across the FBG. This thermal gradient induces a thermal expansion of the grating spaces and a change in the index of refraction that results in the optical benefits outlined above. The location of, and the magnitude of this thermal gradient determines the final optical performance.

Due to the fact that the thermal mass of the FBG is quite small, the application of thermal stress can be made dynamically; this dynamic and preferably periodic stress greatly increases the SBS suppression of the laser. Also, it should be noted, that if the fiber is plated with an electrically conductive medium, an alternating current passed though the plated medium is sufficient to generate an effective substantially aperiodic thermal gradient. Although thermal stress is induced by local heating in one exemplary embodiment, the temperature dependence of the FBG refractive index may also be relevant.

Notwithstanding, exemplary embodiments of the present invention serve to lessen SBS in a system having a narrow line width laser, by varying the spectral response of the FBG or filter, by way of thermal, mechanical or any other suitable method for providing stress to the FBG or filter.

There are many alternative methods that can be used to impose both thermal and mechanical stress sufficient to implement the principles of the present invention. Mechanical stress may also be imposed on the FBG by subjecting it to sound waves, vibration, or, if first metalized with a magnetic material, a magnetic field. The present invention is not limited to the above referenced methods of stress inducement. According to the principles of the present invention, the application of a time varying stress includes any methods which will change the spectral response of the grating in a time varying manner. The time varying stress preferably is applied in a periodic manner and may have a frequency of about 50 to 500 Hertz, and preferably 180 to 220 Hertz.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come within the meaning and range of equivalents thereof are intended to be embraced therein.

What is claimed is:

1. An optical transmitter comprising:
an external cavity laser for generating an optical signal, and transmitting the optical signal over a dispersive fiber optic link; and
an electronic circuit coupled to the external cavity laser to change spectral characteristics of the external cavity laser through changing physical properties of the external cavity laser by applying a periodic stress or an aperiodic stress to the external cavity laser, thereby reducing an effect of noise in a received signal arising from stimulated Brillouin scattering (SBS) generated in the dispersive fiber optic link.

2. The optical transmitter of claim 1, wherein the electronic circuit provides the periodic stress or the aperiodic stress by providing a thermal variation to the external cavity laser.

3. The optical transmitter of claim 2, wherein the electronic circuit provides the thermal variation by applying a current.

4. The optical transmitter of claim 2, wherein the thermal variation on an order of a few degrees Fahrenheit or Celsius with a frequency of 50 to 500 Hertz is provided to the external cavity laser.

5. The optical transmitter of claim 4, wherein the thermal variation has a frequency of 180 to 220 Hertz.

6. The optical transmitter of claim 2, wherein the electronic circuit includes a heating element for applying heat to the external cavity laser, thereby providing the thermal variation.

7. The optical transmitter of claim 1, wherein the electronic circuit provides the periodic stress with a frequency of 50 to 500 Hertz.

8. The optical transmitter of claim 7, wherein the periodic stress has the frequency of 180 to 220 Hertz.

9. The optical transmitter of claim 1, wherein the optical signal is launched at 1550 nm.

10. The optical transmitter of claim 1, wherein the external cavity laser comprises a semiconductor laser coupled to a fiber Bragg grating (FBG), and the periodic stress or the aperiodic stress is applied to the FBG.

11. In an optical system having an optical transmission source in a form of a light source optically coupled with an in-line grating to form a laser, a method of lessening effects of noise in a received signal arising from stimulated Brillouin scattering (SBS) generated in a dispersive fiber optic link optically coupled with the laser, the method comprising:
applying a time varying stress to the in-line grating so as to change spectral characteristics of the in-line grating.

12. The method of claim 11, wherein the time varying stress applied to the in-line grating is a periodic stress.

13. The method of claim 12, wherein a frequency of the periodic stress is between about 50 to 500 Hertz.

14. The method of claim 11, wherein the spectral characteristics include an optical period of the in-line grating or an amount of chirp on the grating.

15. The method of claim 14, wherein the change in the optical period is a combination of a change in a physical period and a change in a refractive index of the in-line grating.

16. The method of claim 11, wherein applying the time varying stress to the in-line grating changes a period of the grating or a refractive index of the grating in a time varying manner, and wherein the in-line grating is a fiber Bragg grating (FBG).

17. The method of claim 11, wherein the laser is a narrow band laser, and wherein a frequency of the optical transmission source is varied by stressing the in-line grating and wherein the frequency of the optical transmission source is dithered by varying the stress applied to the in-line grating.

18. The method of claim 11, wherein the time varying stress applied to the grating is at a rate that is sufficient to substantially lessen the effects of the SBS.

19. The method of claim 11, wherein the time varying stress is applied randomly or pseudo-randomly.

20. The method of claim 11, wherein the time varying stress is applied aperiodically.

21. The method of claim 11, wherein the time varying stress is applied by utilizing a thermal mechanical transducer.

22. The method of claim 11, wherein a period of the in-line grating is modified by time varying refractive index changes induced thermally by utilizing a heating element.

23. The method of claim 11, wherein the dispersive fiber optic link comprises an SMF-28 optical fiber.

24. A system comprising:
a dispersive fiber optic link;
a laser optically coupled with the dispersive fiber optic link, wherein the laser includes a narrow band optical source and a fiber Bragg grating (FBG) forming an output facet of the laser; and
means for dithering the spectral response of the FBG to reduce noise in a received signal arising from stimulated Brillouin scattering (SBS) generated in the dispersive optical fiber link.

25. A system for lessening effects of noise in a received signal arising from stimulated Brillouin scattering (SBS) generated in a dispersive optical fiber link, the system comprising:
a narrow band laser including a fiber Bragg grating (FBG) for transmitting an optical signal; and
means for applying a time varying stress to the FBG so as to change its operating characteristics, the time varying stress being dithered with a frequency of 50 to 500 Hertz.

26. The system of claim 25, wherein the time varying stress is dithered with a frequency of 180 to 220 Hertz.

27. An external cavity laser comprising:
a butterfly package having peripheral walls that define a cavity and a plurality of pins extending from at least one of the peripheral walls;
a laser for generating an optical signal disposed in the package;
a dispersive fiber optic link for receiving the optical signal and for carrying the optical signal from the laser to an outside of the butterfly package;
a fiber Bragg grating (FBG) disposed between the laser and the optical link; and
a heating element disposed adjacent to the FBG,
wherein a signal is applied through one of the pins to the heating element, thereby alternately heating and cooling the FBG.

28. The external cavity laser of claim 27, wherein the mount is formed using a material suitable for rapid heating and cooling by applying the periodic signal in a form of a current.

29. The external cavity laser of claim 27, wherein the periodic heating and cooling of the mount changes physical properties of the FBG, thereby reducing an effect of noise in a received signal arising from stimulated Brillouin scattering (SBS) generated in the dispersive optical fiber link.
